(19) United States
(12) Patent Application Publication
(10) Pub. No.: US 2025/0358657 A1
(43) Pub. Date: Nov. 20, 2025

(54) CONFIGURATIONS AND COMPUTATIONAL RESOURCE COUNTING FOR TIME DOMAIN CHANNEL STATE INFORMATION BURSTS

(71) Applicant: QUALCOMM Incorporated, San Diego, CA (US)

(72) Inventors: Jing DAI, Beijing (CN); Chenxi HAO, Beijing (CN); Min HUANG, Beijing (CN); Hao XU, Beijing (CN)

(21) Appl. No.: 18/867,641

(22) PCT Filed: Jul. 27, 2022
(86) PCT No.: PCT/CN2022/108169

§ 371 Date: Nov. 20, 2024

(51) Int. Cl. H04W 24/10; H04L 5/00

(52) U.S. Cl. CPC H04W 24/10; H04L 5/0048

(57) ABSTRACT

Various aspects of the present disclosure generally relate to wireless communication. In some aspects, a user equipment (UE) may receive channel state information (CSI) report configuration information indicative of a computational resource counting configuration associated with processing time domain (TD) CSI associated with a CSI-reference signal (CSI-RS) burst configuration, wherein the CSI-RS burst configuration corresponds to at least one burst of CSI-reference signal (CSI-RS) occasions. The UE may transmit a CSI report based at least in part on the CSI report configuration. Numerous other aspects are described.

### FIELD OF THE DISCLOSURE

Aspects of the present disclosure generally relate to wireless communication and to techniques and apparatuses for configurations and computations resource counting for time domain channel state information bursts.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive channel state information (CSI) report configuration information indicative of a computational resource counting configuration associated with processing time domain (TD) CSI associated with a CSI-RS burst configuration, wherein the CSI-RS burst configuration corresponds to at least one burst of CSI-reference signal (CSI-RS) occasions. The one or more processors may be configured to transmit a CSI report based at least in part on the CSI report configuration.

Some aspects described herein relate to a network node for wireless communication. The network node may include a memory and one or more processors coupled to the memory. The one or more processors may be configured to transmit CSI report configuration information indicative of a computational resource counting configuration associated with processing TD CSI associated with a CSI-RS burst configuration, wherein the CSI-RS burst configuration corresponds to at least one burst of CSI-RS occasions. The one or more processors may be configured to receive a CSI report based at least in part on the CSI report configuration.

Some aspects described herein relate to a UE for wireless communication. The UE may include a memory and one or more processors coupled to the memory. The one or more processors may be configured to receive CSI report configuration information indicative of a CSI-RS burst configuration corresponding to at least one burst of CSI-RS occasions. The one or more processors may be configured to receive at least one CSI-RS based on the CSI-RS burst configuration.

Some aspects described herein relate to a network node for wireless communication. The network node may include a memory and one or more processors coupled to the memory. The one or more processors may be configured to transmit CSI report configuration information indicative of a CSI-RS burst configuration corresponding to at least one burst of CSI-RS occasions. The one or more processors may be configured to transmit at least one CSI-RS based on the CSI-RS burst configuration.

Some aspects described herein relate to a method of wireless communication performed by a UE. The method may include receiving CSI report configuration information indicative of a computational resource counting configuration associated with processing TD CSI associated with a CSI-RS burst configuration, wherein the CSI-RS burst configuration corresponds to at least one burst of CSI-RS occasions. The method may include transmitting a CSI report based at least in part on the CSI report configuration.

Some aspects described herein relate to a method of wireless communication performed by a network node. The method may include transmitting CSI report configuration information indicative of a computational resource counting configuration associated with processing TD CSI associated with a CSI-RS burst configuration, wherein the CSI-RS burst configuration corresponds to at least one burst of CSI-RS occasions. The method may include receiving a CSI report based at least in part on the CSI report configuration.

Some aspects described herein relate to a method of wireless communication performed by a UE. The method may include receiving CSI report configuration information indicative of a CSI-RS burst configuration corresponding to at least one burst of CSI-RS occasions. The method may include receiving at least one CSI-RS based on the CSI-RS burst configuration.

Some aspects described herein relate to a method of wireless communication performed by a network node. The method may include transmitting CSI report configuration information indicative of a CSI-RS burst configuration corresponding to at least one burst of CSI-RS occasions. The method may include transmitting at least one CSI-RS based on the CSI-RS burst configuration.

Some aspects described herein relate to a non-transitory computer-readable medium that stores a set of instructions for wireless communication by a UE. The set of instructions, when executed by one or more processors of the UE, may cause the UE to receive CSI report configuration information indicative of a computational resource counting configuration associated with processing TD CSI associated with a CSI-RS burst configuration, wherein the CSI-RS burst configuration corresponds to at least one burst of CSI-RS occasions. The set of instructions, when executed by one or more processors of the UE, may cause the UE to transmit a CSI report based at least in part on the CSI report configuration.

Some aspects described herein relate to a non-transitory computer-readable medium that stores a set of instructions for wireless communication by a network node. The set of instructions, when executed by one or more processors of the network node, may cause the network node to transmit CSI report configuration information indicative of a computational resource counting configuration associated with processing TD CSI associated with a CSI-RS burst configuration, wherein the CSI-RS burst configuration corresponds to at least one burst of CSI-RS occasions. The set of instructions, when executed by one or more processors of the network node, may cause the network node to receive a CSI report based at least in part on the CSI report configuration.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive CSI report configuration information indicative of a CSI-RS burst configuration corresponding to at least one burst of CSI-RS occasions. The set of instructions, when executed by one or more processors of the one or more instructions that, when executed by one or more processors of an UE, may cause the one or more instructions that, when executed by one or more processors of an UE to receive at least one CSI-RS based on the CSI-RS burst configuration.

Some aspects described herein relate to a non-transitory computer-readable medium that stores a set of instructions for wireless communication by a network node. The set of instructions, when executed by one or more processors of the network node, may cause the network node to transmit CSI report configuration information indicative of a CSI-RS burst configuration corresponding to at least one burst of CSI-RS occasions. The set of instructions, when executed by one or more processors of the network node, may cause the network node to transmit at least one CSI-RS based on the CSI-RS burst configuration.

Some aspects described herein relate to an apparatus for wireless communication. The apparatus may include means for receiving CSI report configuration information indicative of a computational resource counting configuration associated with processing TD CSI associated with a CSI-RS burst configuration, wherein the CSI-RS burst configuration corresponds to at least one burst of CSI-RS occasions. The apparatus may include means for transmitting a CSI report based at least in part on the CSI report configuration.

Some aspects described herein relate to an apparatus for wireless communication. The apparatus may include means for transmitting CSI report configuration information indicative of a computational resource counting configuration associated with processing TD CSI associated with a CSI-RS burst configuration, wherein the CSI-RS burst configuration corresponds to at least one burst of CSI-RS occasions. The apparatus may include means for receiving a CSI report based at least in part on the CSI report configuration.

Some aspects described herein relate to an apparatus for wireless communication. The apparatus may include means for receiving CSI report configuration information indicative of a CSI-RS burst configuration corresponding to at least one burst of CSI-RS occasions. The apparatus may include means for receiving at least one CSI-RS based on the CSI-RS burst configuration.

Some aspects described herein relate to an apparatus for wireless communication. The apparatus may include means for transmitting CSI report configuration information indicative of a CSI-RS burst configuration corresponding to at least one burst of CSI-RS occasions. The apparatus may include means for transmitting at least one CSI-RS based on the CSI-RS burst configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of channel state information reference signal (CSI-RS) beam management, in accordance with the present disclosure.

FIG. 5 is a diagram illustrating an example associated with configurations and computations resource counting for time domain channel state information (TD CSI) bursts, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

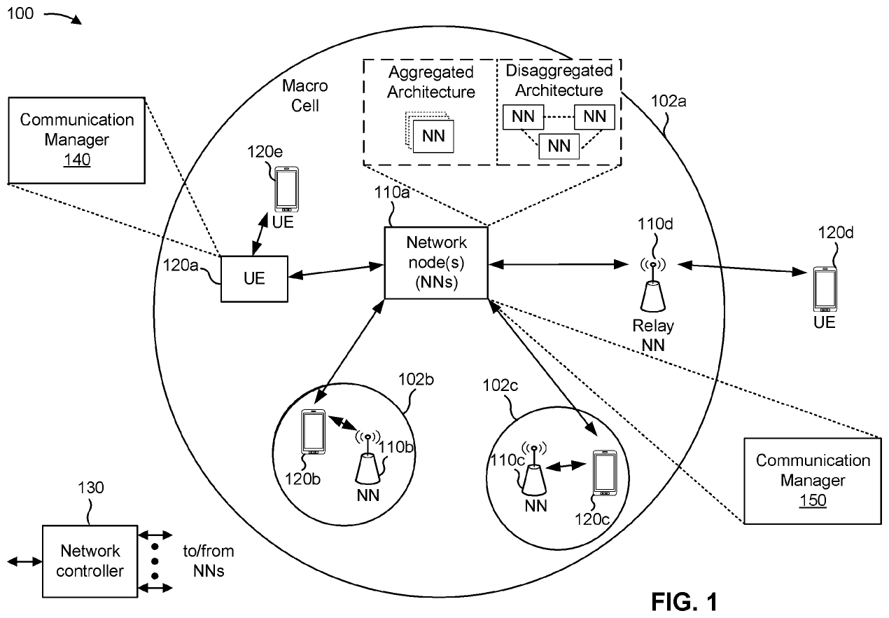

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CLs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive channel state information (CSI) report configuration information indicative of a computational resource counting configuration associated with processing time domain (TD) CSI associated with a CSI-RS burst configuration, wherein the CSI-RS burst configuration corresponds to at least one burst of CSI-reference signal (CSI-RS) occasions; and transmit a CSI report based at least in part on the CSI report configuration.

In some aspects, the communication manager 140 may receive CSI report configuration information indicative of a CSI-RS burst configuration corresponding to at least one burst of CSI-RS occasions; and receive at least one CSI-RS based on the CSI-RS burst configuration. Additionally, or alternatively, the communication manager 140 may perform one or more other operations described herein.

In some aspects, the network node 110 may include a communication manager 150. As described in more detail elsewhere herein, the communication manager 150 may transmit CSI report configuration information indicative of a computational resource counting configuration associated with processing TD CSI associated with a CSI-RS burst configuration, wherein the CSI-RS burst configuration corresponds to at least one burst of CSI-RS occasions; and receive a CSI report based at least in part on the CSI report configuration.

In some aspects, the communication manager 150 may transmit CSI report configuration information indicative of a CSI-RS burst configuration corresponding to at least one burst of CSI-RS occasions; and transmit at least one CSI-RS based on the CSI-RS burst configuration. Additionally, or alternatively, the communication manager 150 may perform one or more other operations described herein.

As indicated above, FIG. 1 is provided as an example. Other examples may differ from what is described with regard to FIG. 1.

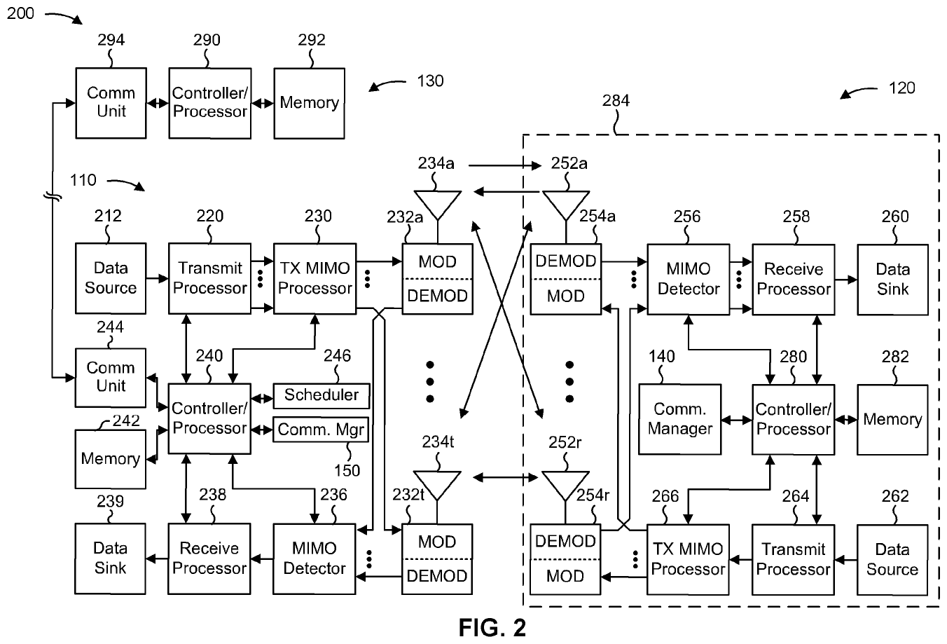

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., 7 downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

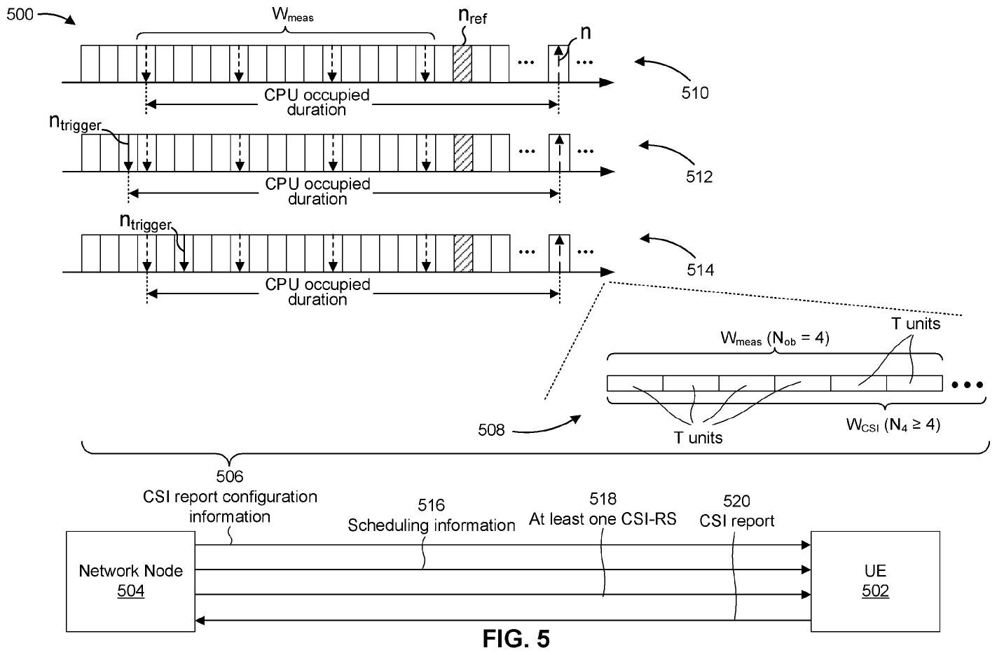

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

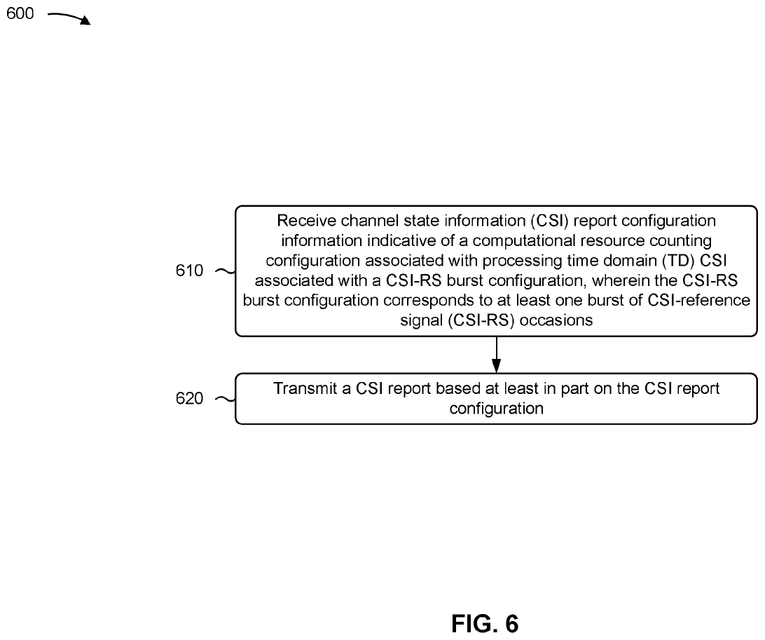

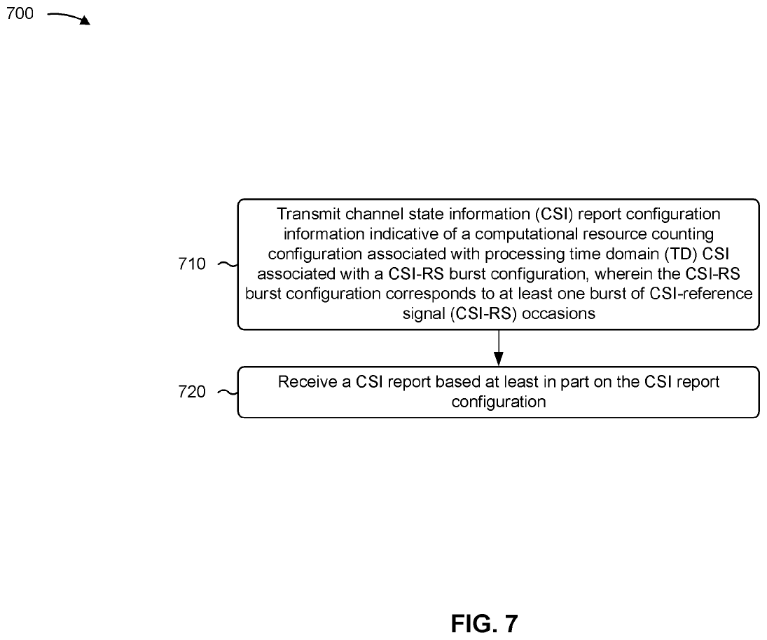

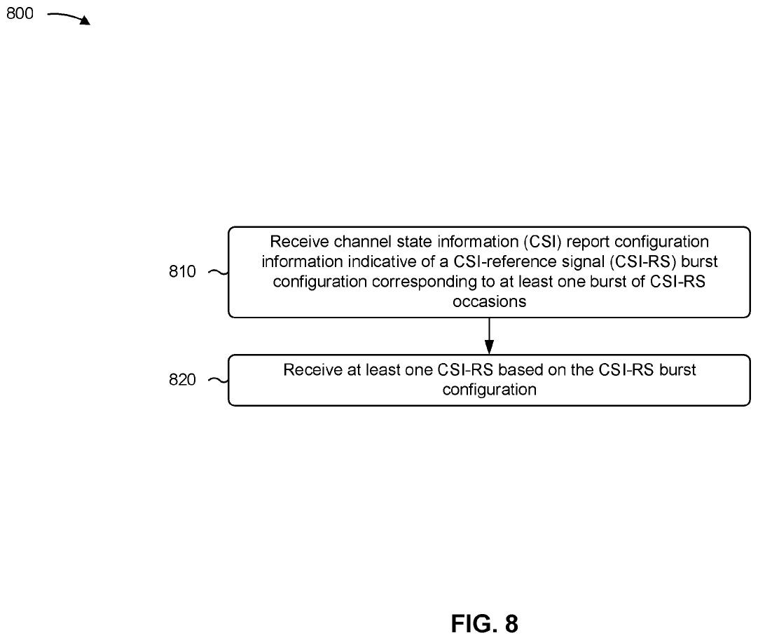

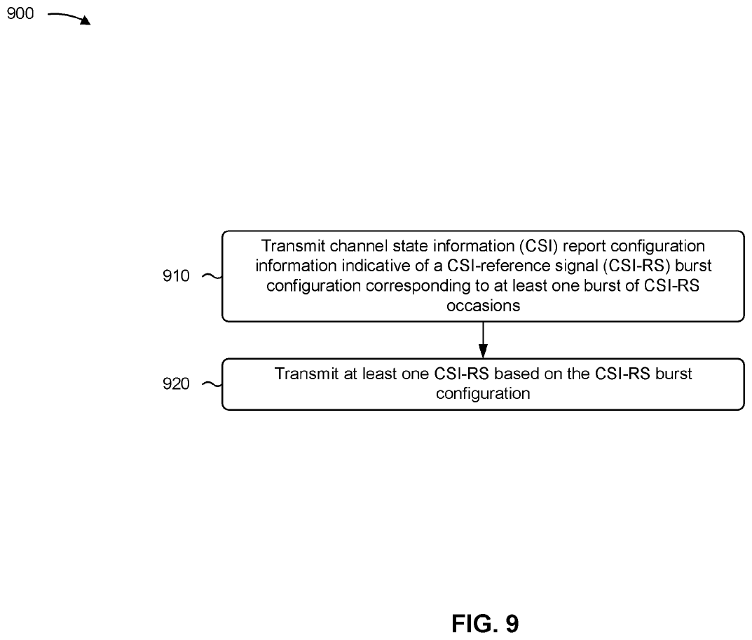

The controller/processor 240 of the network node 110, the controller/processor 280 of the UE 120, and/or any other component(s) of FIG. 2 may perform one or more techniques associated with configurations and computations resource counting for TD CSI bursts, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving CSI report configuration information indicative of a computational resource counting configuration associated with processing TD CSI associated with a CSI-RS burst configuration, wherein the CSI-RS burst configuration corresponds to at least one burst of CSI-RS occasions; and/or means for transmitting a CSI report based at least in part on the CSI report configuration. In some aspects, the UE includes means for receiving CSI report configuration information indicative of a CSI-RS burst configuration corresponding to at least one burst of CSI-RS occasions; and/or means for receiving at least one CSI-RS based on the CSI-RS burst configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting CSI report configuration information indicative of a computational resource counting configuration associated with processing TD CSI associated with a CSI-RS burst configuration, wherein the CSI-RS burst configuration corresponds to at least one burst of CSI-RS occasions; and/or means for receiving a CSI report based at least in part on the CSI report configuration. In some aspects, the network node includes means for transmitting CSI report configuration information indicative of a CSI-RS burst configuration corresponding to at least one burst of CSI-RS occasions; and/or means for transmitting at least one CSI-RS based on the CSI-RS burst configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

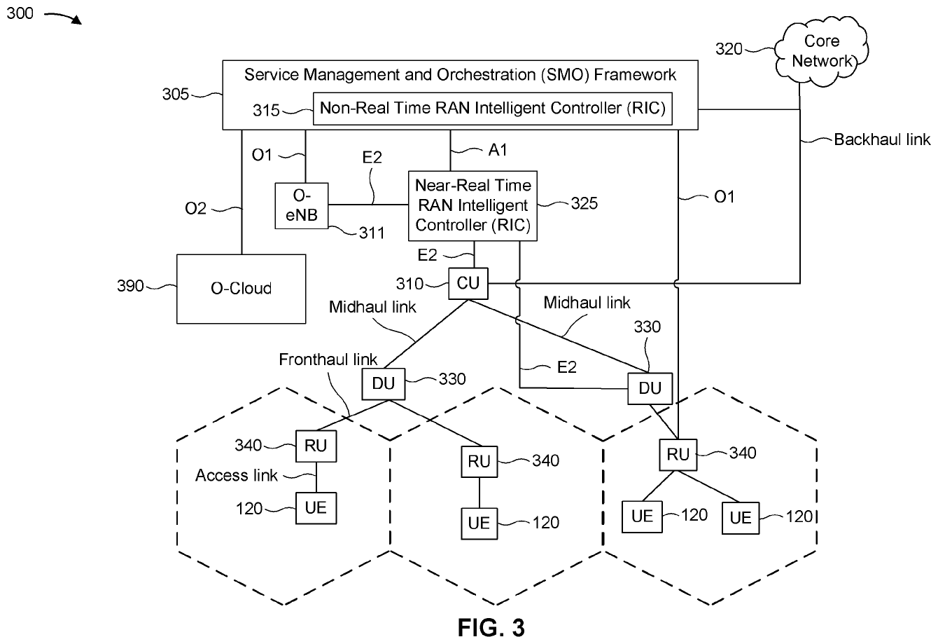

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

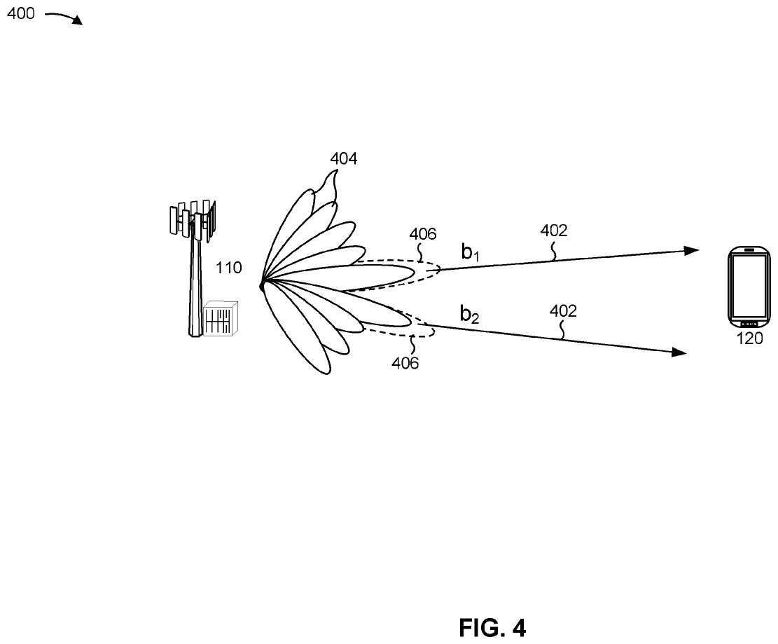

FIG. 4 is a diagram illustrating an example 400 of CSI-RS beam management, in accordance with the present disclosure. As shown in FIG. 4, example 400 includes a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. As shown by reference number 402, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

A first beam management procedure (e.g., P1 CSI-RS beam management), may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120.

A second beam management procedure (e.g., P2 CSI-RS beam management), may be referred to as a beam refinement procedure, a network node beam refinement procedure, a TRP beam refinement procedure, and/or a transmit beam refinement procedure. The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

A third beam management procedure (e.g., P3 CSI-RS beam management) may be referred to as a beam refinement procedure, a UE beam refinement procedure, and/or a receive beam refinement procedure. The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

For Type I CSI feedback, a codebook for CSI may define a set of discrete Fourier transform (DFT) beams 404 in the spatial domain. In some aspects, each beam 404 in the set of beams 404 is orthogonal with the other beams 404 in the set of beams 404. In some aspects, a beam 404 may be represented by a DFT vector, and/or may be identified by a beam index (for example, b₁, b₂, and so on). A network node 110 may transmit CSI-RSs for the set of beams 404 in the codebook, and a UE 120 may measure the CSI-RS for a set of candidate beams 404 (for example, one or more beams in the codebook). The UE 120 may select the best beam 404 or a set of best beams 404 among the set of candidate beams 404 based at least in part on the measurements. The UE 120 may transmit CSI feedback (for example, in a CSI report) to indicate the selected beam(s) 404 to the network node 110. For example, the selected beam(s) 404 may be indicated using a precoding matrix indicator (PMI). However, using Type I CSI feedback may limit the spatial resolution of beams 404 (for example, candidate beams may be limited to the beams in the codebook) and may result in selection of a worse beam 404 than could otherwise be used (for example, by linearly combining multiple DFT vectors corresponding to different beams 404). The UE 120 and the network node 110 may use the selected beam 404 or a beam 404 selected from the set of beams 404 to communicate.

For Type II CSI feedback, a codebook for CSI may include multiple oversampled DFT beams 406, which may not all be orthogonal with one another. In some aspects, the beams 406 included in the codebook may be separated into multiple groups of orthogonal beams 406. The UE 120 may measure CSI-RSs, may select a group (for example, the best group) based at least in part on the measurements, and may analyze different linear combinations of two or more beams 406 in the group. The UE 120 may determine whether any of the linear combinations form a beam 406 with better spatial resolution than a single beam 406 in the group. If so, the UE 120 may transmit CSI feedback (for example, in a CSI report) that indicates the beam indexes of the selected beams to be combined (shown as b₁ and b₂ in FIG. 4) and the linear combination coefficients (shown as c₁ for beam b₁ and c₂ for beam b₂ in FIG. 4) to be applied to each selected beam to form the beam with the better spatial resolution. The UE 120 and/or the network node 110 may configure a beam using the indicated beam indexes and linear combination coefficients (sometimes referred to herein as “coefficients”) and may communicate via the configured beam.

In some aspects, the UE 120 may report CSI feedback for multiple sub-bands (for example, each sub-band via which the UE 120 is capable of communicating with the base station 110). In this case, the UE 120 may report beam indexes and corresponding coefficients for multiple sub-bands (for example, each sub-band). In some aspects, the beam indexes may be common across sub-bands, but different sub-bands may be associated with different coefficients (for example, different amplitude coefficients, different phase coefficients, and/or the like). As a result, Type II CSI feedback may consume more overhead than Type I CSI feedback but may result in a better beam used for communications, thereby resulting in higher throughput, lower latency, less likelihood of beam failure, and/or the like. To reduce the overhead used for Type II CSI feedback, the UE 120 and/or the base station 110 may employ Type II CSI compression.

In Type II CSI compression, a precoding matrix W for a layer of a transmission may be represented by

$$W = {W}_{1} \times {\tilde{W}}_{2} \times {W}_{f}^{H} ,$$

where W₁ is a spatial domain matrix formed using selected spatial domain bases, W_{f} is a frequency domain matrix formed using selected frequency domain bases, and \tilde{W}₂ is a coefficient matrix. However, the type II precoding matrix can be ineffective for high-velocity UEs (e.g., vehicular UEs and/or non-terrestrial UEs, among other examples).

For high-velocity UEs (which results in a high-velocity channel), a UE can use a time-domain (TD) codebook to provide TD CSI, in which the codebook is used to represent the fast-varying (over time instance n) precoding matrix as

$$W ( n ) = {W}_{1} \times {\tilde{W}}_{2} ( n ) \times {W}_{f}^{H} .$$

Compression of the coefficient matrix \tilde{W}₂(n), n=0, . . . , N₄−1 into a doppler domain may facilitate reduced overhead for CSI reporting associated with a high-velocity channel. For example, the time instances 0, . . . , N_{ob}−1 can correspond to observations and the time instances N_{ob}+1, . . . , N₄−1 can correspond to extrapolated CSI measurements. In some cases, the spatial domain bases and the frequency domain bases can generally be constant, while the coefficient matrix can vary with the movement of the UE. In some cases, for example, the UE can report only CSI-RS observations (e.g., N_{ob}=N₄). In this case, CSI compression occurs at the UE and extrapolation occurs at the network node. In some cases, at the UE can report both observations and extrapolations (e.g., N_{ob}<N₄). In this case, both compression and extrapolation occur at the UE. In some aspects, for example, the UE 120 can detect a CSI reporting trigger at a time instance n_{trigger} and perform CSI measurements during a measurement window Wₘₑₐₛ. The UE 120 can be configured to transmit the TD CSI at a time instance n using a physical uplink shared channel (PUSCH) transmission during a PUSCH occasion.

In some cases, a CSI-RS configuration may include a periodic CSI-RS configuration and may be specified by a periodicity and an offset. A CSI-RS configuration may include an enhanced periodic CSI-RS configuration, in which the periodicity applies to bursts of CSI-RS occasions. The enhanced periodic CSI-RS configuration may be specified by parameters such as periodicity and/or burst duration, in addition to offset. A CSI-RS configuration may include an aperiodic CSI-RS configuration that may include burst over multiple slots.

In some cases, the UE 120 may compute one or more CSI processing parameters in connection with the CSI measuring and reporting procedures described above. For example, the UE 120 may receive a CSI report configuration (e.g., a CSI reporting setting) and may compute one or more CSI processing parameters in connection with performing measurements or the like associated with the corresponding report. For example, the UE 120 may compute one or more CSI processing parameters by counting a number of simultaneously occupied CSI processing units (CPUs) associated with a CSI report, a number of simultaneously active CSI resources associated with a CSI report, and/or similar CSI processing parameters.

For a periodic or semi-persistent CSI report, the quantity, O_{CPU} may be a quantity of CPUs occupied from the first symbol of the earliest reference signal (e.g., CSI-RS) in the latest occasion no later than a CSI reference resource to the last symbol of a PUSCH/physical uplink control channel (PUCCH) carrying the report. For an aperiodic report, O_{CPU} may be a quantity of CPUs occupied from a triggering physical downlink control channel (PDCCH) (CSI request DCI) to the PUSCH (report). In some cases, O_{CPU}=K_{S} where K_{S} is the total number of CSI-RS resources in the CSI-RS resource set. For a special case 1, all CPUs are occupied such that O_{CPU}=N_{CPU}, where N_{CPU} is a number of CPUs that the UE 120 is capable of occupying. For a special case 2, O_{CPU}=2N+M. In some cases, the UE 120 can drop some lower-priority CSI reports until the total number

$${\sum }_{n} {O}_{C P U}^{( n )}$$

does not exceed N_{CPU} (total supported by UE for simultaneous CSI calculation).

In some cases, the UE 120 may determine a count of active CSI-RS resource/ports during an active duration. The active duration for a periodic CSI-RS configuration may refer to a time period between RRC configuration and RRC release. An active duration for a semi-persistent CSI-RS configuration may refer to a time period between a MAC CE activation and a deactivation. An active duration for an aperiodic CSI-RS configuration may refer to a time period between a triggering PDCCH (first symbol) and a report PUSCH (last symbol).

The quantity of active ports/resources may be determined by counting the CSI-RS resources/ports multiple times. For example, if a CSI-RS resource is referred N times by one or more report settings, the CSI-RS resource/ports can be counted N times. In some cases, in any slot, the UE 120 may not be expected to have more active CSI-RS ports or active CSI-RS resources in active bandwidth parts (BWPs) than reported as a UE capability. However, counting computational resources is often based on a per-CSI-RS counting scheme and does not take into account bursts of CSI-RS occasions. Additionally, in some cases, RRC configurations can configure CSI-RSs on a per-CSI-RS basis, but do not account for CSI-RS bursts.

Some aspects of the techniques and apparatuses described herein may facilitate computation resource counting for TD CSI bursts. Some aspects of the techniques and apparatus described herein may provide for CSI-RS burst configuration. For example, in some aspects, a UE may receive CSI report configuration information indicative of a computational resource counting configuration associated with processing TD CSI associated with a CSI-RS burst configuration. The CSI-RS burst configuration may correspond to at least one burst of CSI-RS occasions. In some aspects, the CSI report configuration may be indicative of a CSI-RS burst configuration corresponding to at least one burst of CSI-RS occasions. In this manner, some aspects may facilitate TD CSI reporting and computational resource management, thereby positively impacting device and/or network performance.

As indicated above, FIG. 4 is provided as an example of beam management procedures. Other examples of beam management procedures may differ from what is described with respect to FIG. 4.

FIG. 5 is a diagram illustrating an example 500 associated with configurations and computations resource counting for TD CSI bursts, in accordance with the present disclosure. As shown in FIG. 5, a UE 502 and a network node 504 may communicate with one another. In some aspects, the UE 502 may be, be similar to, include, or be included in, the UE 120 depicted in FIGS. 1-4. In some aspects, the network node 504 may be, be similar to, include, or be included in, the network node 110 depicted in FIGS. 1-4.

As shown by reference number 506, the network node 504 may transmit, and the UE 502 may receive, CSI report configuration information. For example, the network node 504 may transmit, and the UE 502 may receive an RRC configuration. The RRC configuration may include the CSI report configuration information. In some aspects, the CSI report configuration information may be indicative of a computational resource counting configuration associated with processing TD CSI associated with a CSI-RS burst configuration. TD CSI may refer to time domain CSI and/or doppler domain CSI. The CSI-RS burst configuration may correspond to at least one burst of CSI-RS occasions. The CSI report may be referred to as a type-II-Doppler CSI report.

In some aspects, the computational resource counting configuration corresponds to a quantity, O_{CPU}, of occupied CPUs associated with the CSI report. The quantity of occupied CPUs may be based on at least one of a first quantity, Non, of time units in a first set of time units or a second quantity, N₄, of time units within a second set of time units. As shown by reference number 508, the first set of time units may include one or more time units within a burst of the at least one burst of CSI-RS occasions. The second set of time units may include one or more time units within a CSI window, and may be referred to as a length of the TD basis and/or a length of the doppler domain (DD) basis.

In some aspects, the quantity, O_{CPU}, of occupied CPUs is greater than one based on the first quantity of time units being greater than one and/or based on the second quantity of time units being greater than one. For example, in some aspects, O_{CPU}>1 may be supported based on N_{ob}>1 and/or N₄>1. For type-II CSI reports, the associated CSI-RS resource set may only include one CSI-RS resource (e.g., O_{CPU}=K_{S}=1 for legacy non-TD type-II CSI). For legacy non-TD type-II CSI, the quantity, O_{CPU}, of occupied CPUs can be seen as O_{CPU}=1 for N_{ob}=N₄=1.

In some aspects, the quantity, O_{CPU}, of occupied CPUs may be directly proportional to the at least one of the first quantity of time units or the second quantity of time units. For example, in some aspects, O_{CPU} may increase with N_{ob} or N₄. In one example, O_{CPU}=N_{ob} or O_{CPU}=N₄. In another example, O_{CPU}=N_{ob}+1 or O_{CPU}=N₄+1. In another example, O_{CPU}=N_{ob}/2 or O_{CPU}=N₄/2. In some aspects, the quantity, O_{CPU}, of occupied CPUs may be a specified value based on the first quantity of time units being greater than one or based on the second quantity of time units being greater than one. For example, O_{CPU} may be defined as a fixed value (e.g. 2 or 4) for N_{ob}>1 or N₄>1.

In some aspects, at least one time unit of the first set of time units or the second set of time units may include a plurality of CSI-RS occasions of a burst of the at least one burst of CSI-RS occasions. In some aspects, the quantity, X, of CSI-RS occasions of the plurality of CSI-RS occasions within the at least one time unit may be irrelevant to the quantity, O_{CPU}, of occupied CPUs. In some aspects, the quantity of occupied CPUs may be further based on the quantity, X, of CSI-RS occasions of the plurality of CSI-RS occasions within the at least one time unit (e.g. O_{CPU}=X·N_{ob} or O_{CPU}=X·N₄).

In some aspects, the occupied CPUs associated with the CSI report may correspond to a CPU occupied duration. The CPU occupied duration may include a time period between an occupied duration start time and a time associated with a PUSCH associated with the CSI report. For example, as shown by reference number 510, a burst of the at least one burst of CSI-RS occasions may include a periodic CSI-RS burst or a semi-persistent CSI-RS burst, the CSI report may include a periodic CSI report or a semi-persistent CSI report, and the occupied duration start time may include a latest burst of the at least one burst of CSI-RS occasions that is not later than a CSI reference resource.

A CSI reference resource (which may be associated with a slot denoted as slot n_{ref}) may be defined for validation testing (e.g., a target block error rate (BLER) of 10%) with a reported CQI (and PMI, if also reported). The frequency resource of the CSI reference signal resource may be the same frequency resource as the measured CSI-RS in the frequency domain. The time resource of a CSI reference signal resource may be a valid downlink slot n-n_{CSI_ref} (prior to the uplink slot n 526 during which the TD CSI is reported). For example, for a periodic or semi-periodic CSI report, n_{CSI_ref} may be the smallest value that is greater than or equal to 4·2^{μ}^{_{DL}} (single CSI-RS) or 5·2^{μ}^{_{DL}} (multiple CSI-RSs), such that slot n-n_{CSI_ref} corresponds to a valid downlink slot. For an aperiodic CSI report, n_{CSI_ref} may be the smallest value that is greater than or equal to [Z′/14], such that slot n-n_{CSI_ref} corresponds to a valid downlink slot (where Z′ may be the required processing timeline between a CSI-RS and the reporting PUSCH occasion). The CSI reference signal resource may include a specified PDSCH pattern. The PDSCH pattern may indicate symbols used within the slot, a DMRS pattern, a subcarrier spacing (SCS), and/or a layer mapping pattern associated with the reported PMI, among other examples.

As shown by reference number 512, a burst of the at least one burst of CSI-RS occasions may include a periodic CSI-RS burst or a semi-persistent CSI-RS burst, the CSI report may include an aperiodic CSI report, and the occupied duration start time may include a time associated with a triggering PDCCH occasion (denoted by n_{trigger}). In some aspects, a burst of the at least one burst of CSI-RS occasions may include an aperiodic CSI-RS burst and the CSI report may include an aperiodic CSI report, and the occupied duration start time may include a time associated with a triggering PDCCH occasion. As shown by reference number 514, a burst of the at least one burst of CSI-RS occasions may include a periodic CSI-RS burst or a semi-persistent CSI-RS burst, the CSI report may include an aperiodic CSI report, and the occupied duration start time may include a latest burst of the at least one burst of CSI-RS occasions that is not later than a CSI reference resource.

In some aspects, the computational resource counting configuration may correspond to a quantity of active CSI-RS resources. In some aspects, the computational resource counting configuration may correspond to a quantity of ports associated with the quantity of active CSI-RS resources. In some aspects, the quantity of ports may be determined based on the quantity of active CSI-RS resources or vice-versa. In some aspects, for example, the quantity of ports may be equal to the quantity of active CSI-RS resources. In some aspects, the quantity of ports may be equal to a product of the quantity of active CSI-RS resources and a quantity of ports associated with each active CSI-RS resource.

In some aspects, the quantity of active CSI-RS resources may be based on at least one of the first quantity, N_{ob}, of time units in a first set of time units or the second quantity, N₄, of time units within a second set of time units. For example, for the number of active resources/ports, the counting can be determined by N_{ob} or N₄. In some aspects, the computational resource counting configuration may correspond to a multiple of the quantity of active CSI-RS resources based on the first quantity of time units being greater than one and/or based on the second quantity of time units being greater than one. For example, the quantity of active CSI-RS resources may be counted for more than one time based on N_{ob}>1 or N₄>1.

In some aspects, the multiple of the quantity of active CSI-RS resources may be equal to the first quantity, N_{ob}, of time units or the second quantity, N₄, of time units. In some aspects, the multiple of the quantity of active CSI-RS resources may include a product of the quantity of active CSI-RS resources and the first quantity of time units. In some aspects, the multiple of the quantity of active CSI-RS resources may include a product of the quantity of active CSI-RS resources and the second quantity of time units. For example, the quantity of active CSI-RS resources may be counted for N_{ob} or N₄ times. In some aspects, the multiple of the quantity of active CSI-RS resources may include a product of the quantity of active CSI-RS resources and a specified value (e.g. 2 or 4).

In some aspects, at least one time unit of the first set of time units or the second set of time units may include a plurality of CSI-RS occasions of a burst of the at least one burst of CSI-RS occasions. In some aspects, the quantity of active CSI-RS resources may be unaffected by a quantity, X, of CSI-RS occasions of the at least one burst of CSI-RS occasions. In some aspects, the quantity of occupied CPUs may be further based on the quantity, X, of CSI-RS occasions of the plurality of CSI-RS occasions within the at least one time unit (e.g., the active CSI-RS resources may be counted for X·N_{ob} or X·N₄ times).

In some aspects, the active duration for periodic CSI-RS configurations may correspond to a time period between an RRC configuration and an RRC release. For a semi-persistent CSI-RS configuration, the active duration may correspond to a time period between a MAC-CE activation and a deactivation. For an aperiodic CSI-RS configuration, the active duration may correspond to a time period between a triggering PDCCH and a report PUSCH.

In some aspects, the CSI report configuration information may be indicative of a CSI-RS burst configuration corresponding to at least one burst of CSI-RS occasions. In some aspects, the CSI-RS burst configuration may include a periodic CSI-RS burst configuration or a semi-persistent CSI-RS burst configuration, and the CSI-RS burst configuration may indicate at least one burst parameter. The at least one burst parameter may include a burst periodicity. The burst periodicity may include a product of a CSI-RS periodicity and a quantity of time units within a CSI window. For example, the burst periodicity, T_{burst}, may be defined as T_{burst}=N₄·T_{CSI-RS}. The at least one burst parameter may include a burst offset. The burst offset may be based on a CSI-RS periodicity and an offset associated with a set of time units within a CSI window. For example, the burst offset T_{burstOffset}, may be defined as T_{burstOffset}=N_{4,offset}·T_{CSI-RS}. In some aspects, the at least one burst parameter may include a burst duration. The burst duration may include a product of a CSI-RS periodicity and a quantity of time units within a burst of the at least one burst of CSI-RS occasions. For example, the burst duration T_{burstDuration}, may be defined as T_{burstDuration}=N_{ob}·T_{CSI-RS}.

In some aspects, for example, slot

$${n}_{s , f}^{μ}$$

for CSI-RS occasions of periodic and/or semi-persistent CSI-RS burst configurations should satisfy:

$$( {N}_{slot}^{frame , μ} {n}_{f} + {n}_{s , f}^{μ} - {T}_{offset} - ( {N}_{4 , offset} + \{ 0 , 1 , … , {N}_{ob} - 1 \} ) \cdot {T}_{CSI - RS} ) mod ( {N}_{4} \cdot {T}_{CSI - RS} ) = 0 ,$$

where {0, 1, . . . , N_{ob}−1} means with any one of these N_{ob} values satisfied for the equation, the associated value of n_{s,f}^{μ} would corresponds to a CSI-RS occasion/slot of periodic and/or semi-persistent CSI-RS burst; T_{CSI-RS} and T_{offset} is configured by CSI-ResourcePeriodicityAndOffset, the system frame number (SFN) n_{f}∈{0, 1, . . . , 1023}, and

$${n}_{s , f}^{μ} ∈ \{ 0 , 1 , … , {N}_{slot}^{frame , μ} - 1 \} , where {N}_{slot}^{frame , μ}$$

is the number of slot in a system frame having subcarrier spacing configuration μ. Examples of

$${N}_{slot}^{frame , μ}$$

are shown in

TABLE 1

| μ | SCS (kHz) | Nₛₗₒₜ^{frame, μ} |
|---|---|---|
| 0 | 15 | 10 |
| 1 | 30 | 20 |
| 2 | 60 | 40 |
| 3 | 120 | 80 |
| 4 | 240 | 160 |

In some aspects, the CSI-RS burst configuration may include an aperiodic CSI-RS burst configuration, and the CSI-RS burst configuration may indicates at least one burst parameter. The at least one burst parameter may include a time interval between consecutive CSI-RS occasions of a burst of the at least one burst of CSI-RS occasions. For example, for aperiodic CSI-RS burst configurations, a time interval Tᵤₙᵢₜ may be defined between consecutive CSI-RS occasions. The at least one burst parameter may include a burst duration. The burst duration may include a product of the time interval and a quantity of time units within a burst of the at least one burst of CSI-RS occasions. For example, the burst duration T_{burstDuration}, may be defined as T_{burstDuration}=N_{ob}·Tᵤₙᵢₜ.

In some aspects, the CSI-RS burst configuration may indicate a CSI-RS resource corresponding to a set of CSI-RS occasions in a burst of the at least one burst of CSI-RS occasions. For example, the CSI-RS occasions within a burst of CSI-RS occasions may be defined as one CSI-RS resource. In some aspects, the CSI-RS burst configuration may indicate a plurality of CSI-RS resources, and each of the plurality of CSI-RS resources may correspond to a respective CSI-RS occasion of a burst of the at least one burst of CSI-RS occasions. For example, the burst of CSI-RS occasions may be defined as N_{ob} CSI-RS resources. In some aspects, the CSI-RS burst configuration may indicate a repetition parameter corresponding to the plurality of CSI-RS resources. In this way, a same downlink spatial relationship across time instances for TD CSI calculations may be maintained.

As shown by reference number 516, the network node 504 may transmit, and the UE 502 may receive, scheduling information (indicated by “n_{trigger}”). For example, in some aspects, the network node 504 may transmit, and the UE 502 may receive, the scheduling information during a PDCCH occasion. The scheduling information may be indicative of a scheduled CSI report (indicated by “n”) corresponding to a PUSCH occasion. In some aspects, the scheduling information may indicate a set of uplink contents associated with the scheduled CSI report. The set of uplink contents may include TD CSI and, in some cases, additional uplink information. For example, in some aspects, the additional uplink information may include at least one of uplink data, an acknowledgement indication, or non-TD CSI.

In some aspects, the UE 502 may receive the scheduling information based on receiving a DCI transmission that indicates scheduling information. In some aspects, the scheduling information may indicate a slot offset associated with the CSI report (e.g., associated with the PUSCH occasion corresponding to the CSI report). For example, a value of a PDCCH-to-PUSCH slot offset, K2, may be indicated. In some aspects, the scheduling information is indicative of a time domain resource allocation (TDRA). The TDRA may indicate the value of K2. In some aspects, the value of the PUSCH slot offset may be RRC configured. In some aspects, the DCI transmission may include an indication of at least one parameter associated with the PUSCH occasion. In some aspects, the at least one parameter may indicate at least one of a frequency domain resource allocation (FDRA), an MCS, an SRS resource indicator (SRI), a quantity of layers, a precoding matrix, an antenna port, a frequency hopping operation, an open-loop power control, and/or a TDRA parameter, among other examples. The TDRA parameter may include, for example, a start and length indicator value (SLIV) and/or a DMRS mapping type, among other examples.

As shown by reference number 518, the network node 504 may transmit, and the UE 502 may receive, at least one CSI-RS. The at least one CSI-RS may be transmitted based on the CSI-RS burst configuration. As shown by reference number 520, the UE 502 may transmit, and the network node 504 may receive, a CSI report. The CSI report may include TD CSI and may be based on the CSI report configuration. The TD CSI may be based on the at least one CSI-RS.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 502) performs operations associated with computations resource counting for TD CSI bursts.

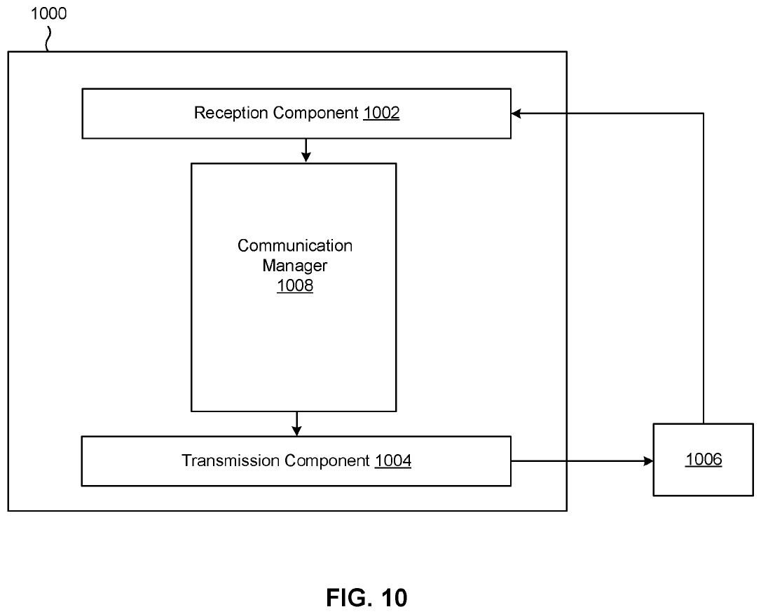

As shown in FIG. 6, in some aspects, process 600 may include receiving CSI report configuration information indicative of a computational resource counting configuration associated with processing TD CSI associated with a CSI-RS burst configuration, wherein the CSI-RS burst configuration corresponds to at least one burst of CSI-RS occasions (block 610). For example, the UE (e.g., using communication manager 1008 and/or reception component 1002, depicted in FIG. 10) may receive CSI report configuration information indicative of a computational resource counting configuration associated with processing TD CSI associated with a CSI-RS burst configuration, wherein the CSI-RS burst configuration corresponds to at least one burst of CSI-RS occasions, as described above.

As further shown in FIG. 6, in some aspects, process 600 may include transmitting a CSI report based at least in part on the CSI report configuration (block 620). For example, the UE (e.g., using communication manager 1008 and/or transmission component 1004, depicted in FIG. 10) may transmit a CSI report based at least in part on the CSI report configuration, as described above.

Process 600 may include additional aspects, such as any single aspect or any combination of aspects described below and/or in connection with one or more other processes described elsewhere herein.

In a first aspect, the computational resource counting configuration corresponds to a quantity of occupied CPUs associated with the CSI report. In a second aspect, alone or in combination with the first aspect, the quantity of occupied CPUs is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window. In a third aspect, alone or in combination with one or more of the first and second aspects, the quantity of occupied CPUs is directly proportional to the at least one of the first quantity of time units or the second quantity of time units. In a fourth aspect, alone or in combination with one or more of the second or third aspects, the quantity of occupied CPUs is greater than one based on the first quantity of time units being greater than one. In a fifth aspect, alone or in combination with the fourth aspect, the quantity of occupied CPUs is a specified value based on the first quantity of time units being greater than one.

In a sixth aspect, alone or in combination with one or more of the second through fifth aspects, the quantity of occupied CPUs is greater than one based on the second quantity of time units being greater than one. In a seventh aspect, alone or in combination with the sixth aspect, the quantity of occupied CPUs is a specified value based on the second quantity of time units being greater than one. In an eighth aspect, alone or in combination with one or more of the second through seventh aspects, at least one time unit of the first set of time units or the second set of time units comprises a plurality of CSI-RS occasions of a burst of the at least one burst of CSI-RS occasions. In a ninth aspect, alone or in combination with the eighth aspect, the quantity of occupied CPUs is further based on a quantity of CSI-RS occasions of the plurality of CSI-RS occasions within the at least one time unit.

In a tenth aspect, alone or in combination with one or more of the first through ninth aspects, the occupied CPUs associated with the CSI report correspond to a CPU occupied duration comprising a time period between an occupied duration start time and a time associated with a physical uplink shared channel associated with the CSI report. In an eleventh aspect, alone or in combination with the tenth aspect, a burst of the at least one burst of CSI-RS occasions comprises a periodic CSI-RS burst or a semi-persistent CSI-RS burst, wherein the CSI report comprises a periodic CSI report or a semi-persistent CSI report, and wherein the occupied duration start time comprises a latest burst of the at least one burst of CSI-RS occasions that is not later than a CSI reference resource. In a twelfth aspect, alone or in combination with the tenth aspect, a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a time associated with a triggering physical downlink control channel occasion. In a thirteenth aspect, alone or in combination with the tenth aspect, a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a latest burst of the at least one burst of CSI-RS occasions that is not later than a CSI reference resource. In a fourteenth aspect, alone or in combination with the tenth aspect, a burst of the at least one burst of CSI-RS occasions comprises an aperiodic CSI-RS burst and the CSI report comprises an aperiodic CSI report, and wherein the occupied duration start time comprises a time associated with a triggering physical downlink control channel occasion.

In a fifteenth aspect, alone or in combination with one or more of the first through fourteenth aspects, the computational resource counting configuration corresponds to a quantity of active CSI-RS resources. In a sixteenth aspect, alone or in combination with the fifteenth aspect, the quantity of active CSI-RS resources is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window. In a seventeenth aspect, alone or in combination with the sixteenth aspect, the computational resource counting configuration corresponds to a multiple of the quantity of active CSI-RS resources based on the first quantity of time units being greater than one. In an eighteenth aspect, alone or in combination with the seventeenth aspect, the multiple of the quantity of active CSI-RS resources comprises a product of the quantity of active CSI-RS resources and the first quantity of time units. In a nineteenth aspect, alone or in combination with one or more of the seventeenth or eighteenth aspects, the multiple of the quantity of active CSI-RS resources comprises a product of the quantity of active CSI-RS resources and a specified value.

In a twentieth aspect, alone or in combination with one or more of the sixteenth through nineteenth aspects, the computational resource counting configuration corresponds to a multiple of the quantity of active CSI-RS resources based on the second quantity of time units being greater than one. In a twenty-first aspect, alone or in combination with the twentieth aspect, the multiple of the quantity of active CSI-RS resources comprises a product of the quantity of active CSI-RS resources and the second quantity of time units. In a twenty-second aspect, alone or in combination with one or more of the twentieth or twenty-first aspects, the multiple of the quantity of active CSI-RS resources comprises a product of the quantity of active CSI-RS resources and a specified value. In a twenty-third aspect, alone or in combination with one or more of the sixteenth through twenty-second aspects, at least one time unit of the first set of time units or the second set of time units comprises a plurality of CSI-RS occasions of a burst of the at least one burst of CSI-RS occasions. In a twenty-fourth aspect, alone or in combination with the twenty-third aspect, the quantity of occupied CPUs is further based on a quantity of CSI-RS occasions of the plurality of CSI-RS occasions within the at least one time unit. In a twenty-fifth aspect, alone or in combination with one or more of the fifteenth through twenty-fourth aspects, the computational resource counting configuration corresponds to a quantity of ports associated with the quantity of active CSI-RS resources.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with computations resource counting for TD CSI bursts.

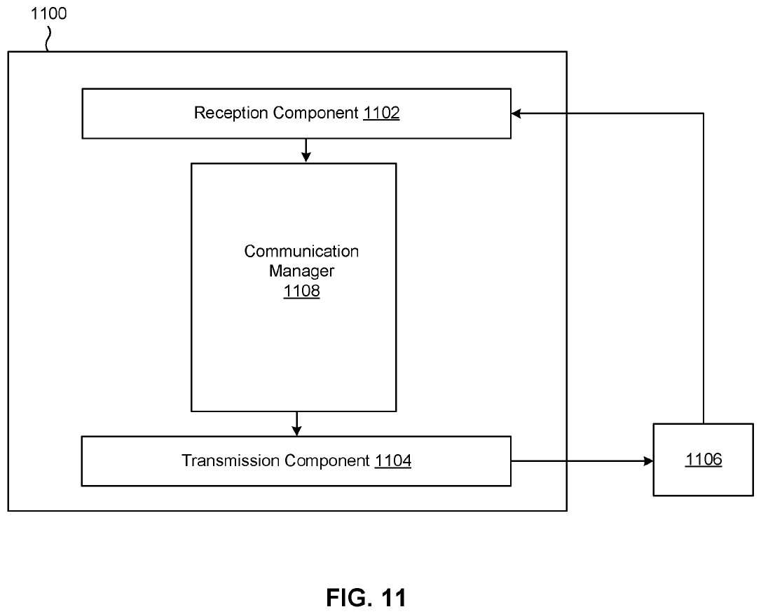

As shown in FIG. 7, in some aspects, process 700 may include transmitting CSI report configuration information indicative of a computational resource counting configuration associated with processing TD CSI associated with a CSI-RS burst configuration, wherein the CSI-RS burst configuration corresponds to at least one burst of CSI-RS occasions (block 710). For example, the network node (e.g., using communication manager 1108 and/or transmission component 1104, depicted in FIG. 11) may transmit CSI report configuration information indicative of a computational resource counting configuration associated with processing TD CSI associated with a CSI-RS burst configuration, wherein the CSI-RS burst configuration corresponds to at least one burst of CSI-RS occasions, as described above.

As further shown in FIG. 7, in some aspects, process 700 may include receiving a CSI report based at least in part on the CSI report configuration (block 720). For example, the network node (e.g., using communication manager 1108 and/or reception component 1102, depicted in FIG. 11) may receive a CSI report based at least in part on the CSI report configuration, as described above.

Process 700 may include additional aspects, such as any single aspect or any combination of aspects described below and/or in connection with one or more other processes described elsewhere herein.

In a first aspect, the computational resource counting configuration corresponds to a quantity of occupied CPUs associated with the CSI report. In a second aspect, alone or in combination with the first aspect, the quantity of occupied CPUs is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window. In a third aspect, alone or in combination with the second aspect, the quantity of occupied CPUs is directly proportional to the at least one of the first quantity of time units or the second quantity of time units.

In a fourth aspect, alone or in combination with one or more of the second or third aspects, the quantity of occupied CPUs is greater than one based on the first quantity of time units being greater than one. In a fifth aspect, alone or in combination with the fourth aspect, the quantity of occupied CPUs is a specified value based on the first quantity of time units being greater than one. In a sixth aspect, alone or in combination with one or more of the second through fifth aspects, the quantity of occupied CPUs is greater than one based on the second quantity of time units being greater than one. In a seventh aspect, alone or in combination with the sixth aspect, the quantity of occupied CPUs is a specified value based on the second quantity of time units being greater than one. In an eighth aspect, alone or in combination with one or more of the second through seventh aspects, at least one time unit of the first set of time units or the second set of time units comprises a plurality of CSI-RS occasions of a burst of the at least one burst of CSI-RS occasions. In a ninth aspect, alone or in combination with the eighth aspect, the quantity of occupied CPUs is further based on a quantity of CSI-RS occasions of the plurality of CSI-RS occasions within the at least one time unit.

In a tenth aspect, alone or in combination with one or more of the first through ninth aspects, the occupied CPUs associated with the CSI report correspond to a CPU occupied duration comprising a time period between an occupied duration start time and a time associated with a physical uplink shared channel associated with the CSI report. In an eleventh aspect, alone or in combination with the tenth aspect, a burst of the at least one burst of CSI-RS occasions comprises a periodic CSI-RS burst or a semi-persistent CSI-RS burst, wherein the CSI report comprises a periodic CSI report or a semi-persistent CSI report, and wherein the occupied duration start time comprises a latest burst of the at least one burst of CSI-RS occasions that is not later than a CSI reference resource. In a twelfth aspect, alone or in combination with the tenth aspect, a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a time associated with a triggering physical downlink control channel occasion. In a thirteenth aspect, alone or in combination with the tenth aspect, a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a latest burst of the at least one burst of CSI-RS occasions that is not later than a CSI reference resource. In a fourteenth aspect, alone or in combination with the tenth aspect, a burst of the at least one burst of CSI-RS occasions comprises an aperiodic CSI-RS burst and the CSI report comprises an aperiodic CSI report, and wherein the occupied duration start time comprises a time associated with a triggering physical downlink control channel occasion.

In a fifteenth aspect, alone or in combination with one or more of the first through fourteenth aspects, the computational resource counting configuration corresponds to a quantity of active CSI-RS resources. In a sixteenth aspect, alone or in combination with the fifteenth aspect, the quantity of active CSI-RS resources is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window. In a seventeenth aspect, alone or in combination with the sixteenth aspect, the computational resource counting configuration corresponds to a multiple of the quantity of active CSI-RS resources based on the first quantity of time units being greater than one. In an eighteenth aspect, alone or in combination with the seventeenth aspect, the multiple of the quantity of active CSI-RS resources comprises a product of the quantity of active CSI-RS resources and the first quantity of time units. In a nineteenth aspect, alone or in combination with one or more of the seventeenth or eighteenth aspects, the multiple of the quantity of active CSI-RS resources comprises a product of the quantity of active CSI-RS resources and a specified value.

In a twentieth aspect, alone or in combination with one or more of the sixteenth through nineteenth aspects, the computational resource counting configuration corresponds to a multiple of the quantity of active CSI-RS resources based on the second quantity of time units being greater than one. In a twenty-first aspect, alone or in combination with the twentieth aspect, the multiple of the quantity of active CSI-RS resources comprises a product of the quantity of active CSI-RS resources and the second quantity of time units. In a twenty-second aspect, alone or in combination with one or more of the twentieth or twenty-first aspects, the multiple of the quantity of active CSI-RS resources comprises a product of the quantity of active CSI-RS resources and a specified value. In a twenty-third aspect, alone or in combination with one or more of the sixteenth through twenty-second aspects, at least one time unit of the first set of time units or the second set of time units comprises a plurality of CSI-RS occasions of a burst of the at least one burst of CSI-RS occasions. In a twenty-fourth aspect, alone or in combination with the twenty-third aspect, the quantity of occupied CPUs is further based on a quantity of CSI-RS occasions of the plurality of CSI-RS occasions within the at least one time unit. In a twenty-fifth aspect, alone or in combination with one or more of the fifteenth through twenty-fourth aspects, the computational resource counting configuration corresponds to a quantity of ports associated with the quantity of active CSI-RS resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 502) performs operations associated with configurations for TD CSI bursts.

As shown in FIG. 8, in some aspects, process 800 may include receiving CSI report configuration information indicative of a CSI-RS burst configuration corresponding to at least one burst of CSI-RS occasions (block 810). For example, the UE (e.g., using communication manager 1008 and/or reception component 1002, depicted in FIG. 10) may receive CSI report configuration information indicative of a CSI-RS burst configuration corresponding to at least one burst of CSI-RS occasions, as described above.

As further shown in FIG. 8, in some aspects, process 800 may include receiving at least one CSI-RS based on the CSI-RS burst configuration (block 820). For example, the UE (e.g., using communication manager 1008 and/or reception component 1002, depicted in FIG. 10) may receive at least one CSI-RS based on the CSI-RS burst configuration, as described above.

Process 800 may include additional aspects, such as any single aspect or any combination of aspects described below and/or in connection with one or more other processes described elsewhere herein.

In a first aspect, the CSI-RS burst configuration comprises a periodic CSI-RS burst configuration or a semi-persistent CSI-RS burst configuration, and wherein the CSI-RS burst configuration indicates at least one burst parameter. In a second aspect, alone or in combination with the first aspect, the at least one burst parameter comprises a burst periodicity, wherein the burst periodicity comprises a product of a CSI-RS periodicity and a quantity of time units within a CSI window. In a third aspect, alone or in combination with one or more of the first and second aspects, the at least one burst parameter comprises a burst offset, wherein the burst offset is based on a CSI-RS periodicity and an offset associated with a set of time units within a CSI window. In a fourth aspect, alone or in combination with one or more of the first through third aspects, the at least one burst parameter comprises a burst duration, wherein the burst duration comprises a product of a CSI-RS periodicity and a quantity of time units within a burst of the at least one burst of CSI-RS occasions.

In a fifth aspect, alone or in combination with one or more of the first through fourth aspects, the CSI-RS burst configuration comprises an aperiodic CSI-RS burst configuration, and wherein the CSI-RS burst configuration indicates at least one burst parameter. In a sixth aspect, alone or in combination with the fifth aspect, the at least one burst parameter comprises a time interval between consecutive CSI-RS occasions of a burst of the at least one burst of CSI-RS occasions. In a seventh aspect, alone or in combination with the sixth aspect, the at least one burst parameter comprises a burst duration, wherein the burst duration comprises a product of the time interval and a quantity of time units within a burst of the at least one burst of CSI-RS occasions.

In an eighth aspect, alone or in combination with one or more of the first through seventh aspects, the CSI-RS burst configuration indicates a CSI-RS resource corresponding to a set of CSI-RS occasions in a burst of the at least one burst of CSI-RS occasions. In a ninth aspect, alone or in combination with one or more of the first through eighth aspects, the CSI-RS burst configuration indicates a plurality of CSI-RS resources, each of the plurality of CSI-RS resources corresponding to a respective CSI-RS occasion of a burst of the at least one burst of CSI-RS occasions. In a tenth aspect, alone or in combination with the ninth aspect, the CSI-RS burst configuration indicates a repetition parameter corresponding to the plurality of CSI-RS resources.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 504) performs operations associated with configurations for TD CSI bursts.

As shown in FIG. 9, in some aspects, process 900 may include transmitting CSI report configuration information indicative of a CSI-RS burst configuration corresponding to at least one burst of CSI-RS occasions (block 910). For example, the network node (e.g., using communication manager 1108 and/or transmission component 1104, depicted in FIG. 11) may transmit CSI report configuration information indicative of a CSI-RS burst configuration corresponding to at least one burst of CSI-RS occasions, as described above.

As further shown in FIG. 9, in some aspects, process 900 may include transmitting at least one CSI-RS based on the CSI-RS burst configuration (block 920). For example, the network node (e.g., using communication manager 1108 and/or transmission component 1104, depicted in FIG. 11) may transmit at least one CSI-RS based on the CSI-RS burst configuration, as described above.

Process 900 may include additional aspects, such as any single aspect or any combination of aspects described below and/or in connection with one or more other processes described elsewhere herein.

In a first aspect, the CSI-RS burst configuration comprises a periodic CSI-RS burst configuration or a semi-persistent CSI-RS burst configuration, and wherein the CSI-RS burst configuration indicates at least one burst parameter. In a second aspect, alone or in combination with the first aspect, the at least one burst parameter comprises a burst periodicity, wherein the burst periodicity comprises a product of a CSI-RS periodicity and a quantity of time units within a CSI window. In a third aspect, alone or in combination with one or more of the first and second aspects, the at least one burst parameter comprises a burst offset, wherein the burst offset is based on a CSI-RS periodicity and an offset associated with a set of time units within a CSI window. In a fourth aspect, alone or in combination with one or more of the first through third aspects, the at least one burst parameter comprises a burst duration, wherein the burst duration comprises a product of a CSI-RS periodicity and a quantity of time units within a burst of the at least one burst of CSI-RS occasions.

In a fifth aspect, alone or in combination with one or more of the first through fourth aspects, the CSI-RS burst configuration comprises an aperiodic CSI-RS burst configuration, and wherein the CSI-RS burst configuration indicates at least one burst parameter. In a sixth aspect, alone or in combination with the fifth aspect, the at least one burst parameter comprises a time interval between consecutive CSI-RS occasions of a burst of the at least one burst of CSI-RS occasions. In a seventh aspect, alone or in combination with the sixth aspect, the at least one burst parameter comprises a burst duration, wherein the burst duration comprises a product of the time interval and a quantity of time units within a burst of the at least one burst of CSI-RS occasions.

In an eighth aspect, alone or in combination with one or more of the first through seventh aspects, the CSI-RS burst configuration indicates a CSI-RS resource corresponding to a set of CSI-RS occasions in a burst of the at least one burst of CSI-RS occasions. In a ninth aspect, alone or in combination with one or more of the first through eighth aspects, the CSI-RS burst configuration indicates a plurality of CSI-RS resources, each of the plurality of CSI-RS resources corresponding to a respective CSI-RS occasion of a burst of the at least one burst of CSI-RS occasions. In a tenth aspect, alone or in combination with the ninth aspect, the CSI-RS burst configuration indicates a repetition parameter corresponding to the plurality of CSI-RS resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008.

In some aspects, the apparatus 1000 may be configured to perform one or more operations described herein in connection with FIG. 5. Additionally, or alternatively, the apparatus 1000 may be configured to perform one or more processes described herein, such as process 600 of FIG. 6, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1008 and/or the reception component 1002 may receive CSI report configuration information indicative of a computational resource counting configuration associated with processing TD CSI associated with a CSI-RS burst configuration, wherein the CSI-RS burst configuration corresponds to at least one burst of CSI-RS occasions. In some aspects, the communication manager 1008 may include one or more antennas, a modem, a controller/processor, a memory, or a combination thereof, of the UE described in connection with FIG. 2. In some aspects, the communication manager 1008 may include the reception component 1002 and/or the transmission component 1004. In some aspects, the communication manager 1008 may be, be similar to, include, or be included in, the communication manager 140 depicted in FIGS. 1 and 2.

The communication manager 1008 and/or the transmission component 1004 may transmit a CSI report based at least in part on the CSI report configuration. The communication manager 1008 and/or the reception component 1002 may receive CSI report configuration information indicative of a CSI-RS burst configuration corresponding to at least one burst of CSI-RS occasions. The communication manager 1008 and/or the reception component 1002 may receive at least one CSI-RS based on the CSI-RS burst configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108.

In some aspects, the apparatus 1100 may be configured to perform one or more operations described herein in connection with FIG. 5. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1108 and/or the transmission component 1104 may transmit CSI report configuration information indicative of a computational resource counting configuration associated with processing TD CSI associated with a CSI-RS burst configuration, wherein the CSI-RS burst configuration corresponds to at least one burst of CSI-RS occasions. In some aspects, the communication manager 1108 may include one or more antennas, a modem, a controller/processor, a memory, or a combination thereof, of the network node described in connection with FIG. 2. In some aspects, the communication manager 1108 may include the reception component 1102 and/or the transmission component 1104. In some aspects, the communication manager 1108 may be, be similar to, include, or be included in, the communication manager 150 depicted in FIGS. 1 and 2.

The communication manager 1108 and/or the reception component 1102 may receive a CSI report based at least in part on the CSI report configuration. The communication manager 1108 and/or the transmission component 1104 may transmit CSI report configuration information indicative of a CSI-RS burst configuration corresponding to at least one burst of CSI-RS occasions. The transmission component 1104 may transmit at least one CSI-RS based on the CSI-RS burst configuration.

The number and arrangement of components shown in FIG. 11 are provided as an example. In practice, there may be additional components, fewer components, different components, or differently arranged components than those shown in FIG. 11.

Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving channel state information (CSI) report configuration information indicative of a computational resource counting configuration associated with processing time domain (TD) CSI associated with a CSI-reference signal (CSI-RS) burst configuration, wherein the CSI-RS burst configuration corresponds to at least one burst of CSI-RS occasions; and transmitting a CSI report based at least in part on the CSI report configuration.

Aspect 2: The method of Aspect 1, wherein the computational resource counting configuration corresponds to a quantity of occupied CSI processing units (CPUs) associated with the CSI report.

Aspect 3: The method of Aspect 2, wherein the quantity of occupied CPUs is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window.

Aspect 4: The method of Aspect 3, wherein the quantity of occupied CPUs is directly proportional to the at least one of the first quantity of time units or the second quantity of time units.

Aspect 5: The method of either of Aspects 3 or 4, wherein the quantity of occupied CPUs is greater than one based on the first quantity of time units being greater than one.

Aspect 6: The method of Aspect 5, wherein the quantity of occupied CPUs is a specified value based on the first quantity of time units being greater than one.

Aspect 7: The method of any of Aspects 3-6, wherein the quantity of occupied CPUs is greater than one based on the second quantity of time units being greater than one.

Aspect 8: The method of Aspect 7, wherein the quantity of occupied CPUs is a specified value based on the second quantity of time units being greater than one.

Aspect 9: The method of any of Aspects 3-8, wherein at least one time unit of the first set of time units or the second set of time units comprises a plurality of CSI-RS occasions of a burst of the at least one burst of CSI-RS occasions.

Aspect 10: The method of Aspect 9, wherein the quantity of occupied CPUs is further based on a quantity of CSI-RS occasions of the plurality of CSI-RS occasions within the at least one time unit.

Aspect 11: The method of any of Aspects 2-10, wherein the occupied CPUs associated with the CSI report correspond to a CPU occupied duration comprising a time period between an occupied duration start time and a time associated with a physical uplink shared channel associated with the CSI report.

Aspect 12: The method of Aspect 11, wherein a burst of the at least one burst of CSI-RS occasions comprises a periodic CSI-RS burst or a semi-persistent CSI-RS burst, wherein the CSI report comprises a periodic CSI report or a semi-persistent CSI report, and wherein the occupied duration start time comprises a latest burst of the at least one burst of CSI-RS occasions that is not later than a CSI reference resource.

Aspect 13: The method of Aspect 11, wherein a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a time associated with a triggering physical downlink control channel occasion.

Aspect 14: The method of Aspect 11, wherein a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a latest burst of the at least one burst of CSI-RS occasions that is not later than a CSI reference resource.

Aspect 15: The method of Aspect 11, wherein a burst of the at least one burst of CSI-RS occasions comprises an aperiodic CSI-RS burst and the CSI report comprises an aperiodic CSI report, and wherein the occupied duration start time comprises a time associated with a triggering physical downlink control channel occasion.

Aspect 16: The method of any of Aspects 1-15, wherein the computational resource counting configuration corresponds to a quantity of active CSI-RS resources.

Aspect 17: The method of Aspect 16, wherein the quantity of active CSI-RS resources is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window.

Aspect 18: The method of Aspect 17, wherein the computational resource counting configuration corresponds to a multiple of the quantity of active CSI-RS resources based on the first quantity of time units being greater than one.

Aspect 19: The method of Aspect 18, wherein the multiple of the quantity of active CSI-RS resources comprises a product of the quantity of active CSI-RS resources and the first quantity of time units.

Aspect 20: The method of either of Aspects 18 or 19, wherein the multiple of the quantity of active CSI-RS resources comprises a product of the quantity of active CSI-RS resources and a specified value.

Aspect 21: The method of any of Aspects 17-20, wherein the computational resource counting configuration corresponds to a multiple of the quantity of active CSI-RS resources based on the second quantity of time units being greater than one.

Aspect 22: The method of Aspect 21, wherein the multiple of the quantity of active CSI-RS resources comprises a product of the quantity of active CSI-RS resources and the second quantity of time units.

Aspect 23: The method of either of Aspects 21 or 22, wherein the multiple of the quantity of active CSI-RS resources comprises a product of the quantity of active CSI-RS resources and a specified value.

Aspect 24: The method of any of Aspects 17-23, wherein at least one time unit of the first set of time units or the second set of time units comprises a plurality of CSI-RS occasions of a burst of the at least one burst of CSI-RS occasions.

Aspect 25: The method of Aspect 24, wherein the quantity of occupied CPUs is further based on a quantity of CSI-RS occasions of the plurality of CSI-RS occasions within the at least one time unit.

Aspect 26: The method of any of Aspects 16-25, the computational resource counting configuration corresponds to a quantity of ports associated with the quantity of active CSI-RS resources.

Aspect 27: A method of wireless communication performed by a network node, comprising: transmitting channel state information (CSI) report configuration information indicative of a computational resource counting configuration associated with processing time domain (TD) CSI associated with a CSI-reference signal (CSI-RS) burst configuration, wherein the CSI-RS burst configuration corresponds to at least one burst of CSI-RS occasions; and receiving a CSI report based at least in part on the CSI report configuration.

Aspect 28: The method of Aspect 27, wherein the computational resource counting configuration corresponds to a quantity of occupied CSI processing units (CPUs) associated with the CSI report.

Aspect 29: The method of Aspect 28, wherein the quantity of occupied CPUs is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window.

Aspect 30: The method of Aspect 29, wherein the quantity of occupied CPUs is directly proportional to the at least one of the first quantity of time units or the second quantity of time units.

Aspect 31: The method of either of Aspects 29 or 30, wherein the quantity of occupied CPUs is greater than one based on the first quantity of time units being greater than one.

Aspect 32: The method of Aspect 31, wherein the quantity of occupied CPUs is a specified value based on the first quantity of time units being greater than one.

Aspect 33: The method of any of Aspects 29-32, wherein the quantity of occupied CPUs is greater than one based on the second quantity of time units being greater than one.

Aspect 34: The method of Aspect 33, wherein the quantity of occupied CPUs is a specified value based on the second quantity of time units being greater than one.

Aspect 35: The method of any of Aspects 29-34, wherein at least one time unit of the first set of time units or the second set of time units comprises a plurality of CSI-RS occasions of a burst of the at least one burst of CSI-RS occasions.

Aspect 36: The method of Aspect 35, wherein the quantity of occupied CPUs is further based on a quantity of CSI-RS occasions of the plurality of CSI-RS occasions within the at least one time unit.

Aspect 37: The method of any of Aspects 28-36, wherein the occupied CPUs associated with the CSI report correspond to a CPU occupied duration comprising a time period between an occupied duration start time and a time associated with a physical uplink shared channel associated with the CSI report.

Aspect 38: The method of Aspect 37, wherein a burst of the at least one burst of CSI-RS occasions comprises a periodic CSI-RS burst or a semi-persistent CSI-RS burst, wherein the CSI report comprises a periodic CSI report or a semi-persistent CSI report, and wherein the occupied duration start time comprises a latest burst of the at least one burst of CSI-RS occasions that is not later than a CSI reference resource.

Aspect 39: The method of Aspect 37, wherein a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a time associated with a triggering physical downlink control channel occasion.

Aspect 40: The method of Aspect 37, wherein a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a latest burst of the at least one burst of CSI-RS occasions that is not later than a CSI reference resource.

Aspect 41: The method of Aspect 37, wherein a burst of the at least one burst of CSI-RS occasions comprises an aperiodic CSI-RS burst and the CSI report comprises an aperiodic CSI report, and wherein the occupied duration start time comprises a time associated with a triggering physical downlink control channel occasion.

Aspect 42: The method of any of Aspects 27-41, wherein the computational resource counting configuration corresponds to a quantity of active CSI-RS resources.

Aspect 43: The method of Aspect 42, wherein the quantity of active CSI-RS resources is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window.

Aspect 44: The method of Aspect 43, wherein the computational resource counting configuration corresponds to a multiple of the quantity of active CSI-RS resources based on the first quantity of time units being greater than one.

Aspect 45: The method of Aspect 44, wherein the multiple of the quantity of active CSI-RS resources comprises a product of the quantity of active CSI-RS resources and the first quantity of time units.

Aspect 46: The method of either of Aspects 44 or 45, wherein the multiple of the quantity of active CSI-RS resources comprises a product of the quantity of active CSI-RS resources and a specified value.

Aspect 47: The method of any of Aspects 43-46, wherein the computational resource counting configuration corresponds to a multiple of the quantity of active CSI-RS resources based on the second quantity of time units being greater than one.

Aspect 48: The method of Aspect 47, wherein the multiple of the quantity of active CSI-RS resources comprises a product of the quantity of active CSI-RS resources and the second quantity of time units.

Aspect 49: The method of either of Aspects 47 or 48, wherein the multiple of the quantity of active CSI-RS resources comprises a product of the quantity of active CSI-RS resources and a specified value.

Aspect 50: The method of any of Aspects 43-49, wherein at least one time unit of the first set of time units or the second set of time units comprises a plurality of CSI-RS occasions of a burst of the at least one burst of CSI-RS occasions.

Aspect 51: The method of Aspect 50, wherein the quantity of occupied CPUs is further based on a quantity of CSI-RS occasions of the plurality of CSI-RS occasions within the at least one time unit.

Aspect 52: The method of any of Aspects 42-51, the computational resource counting configuration corresponds to a quantity of ports associated with the quantity of active CSI-RS resources.

Aspect 53: A method of wireless communication performed by a user equipment (UE), comprising: receiving channel state information (CSI) report configuration information indicative of a CSI-reference signal (CSI-RS) burst configuration corresponding to at least one burst of CSI-RS occasions; and receiving at least one CSI-RS based on the CSI-RS burst configuration.

Aspect 54: The method of Aspect 53, wherein the CSI-RS burst configuration comprises a periodic CSI-RS burst configuration or a semi-persistent CSI-RS burst configuration, and wherein the CSI-RS burst configuration indicates at least one burst parameter.

Aspect 55: The method of Aspect 54, wherein the at least one burst parameter comprises a burst periodicity, wherein the burst periodicity comprises a product of a CSI-RS periodicity and a quantity of time units within a CSI window.

Aspect 56: The method of either of Aspects 54 or 55, wherein the at least one burst parameter comprises a burst offset, wherein the burst offset is based on a CSI-RS periodicity and an offset associated with a set of time units within a CSI window.

Aspect 57: The method of any of Aspects 54-56, wherein the at least one burst parameter comprises a burst duration, wherein the burst duration comprises a product of a CSI-RS periodicity and a quantity of time units within a burst of the at least one burst of CSI-RS occasions.

Aspect 58: The method of any of Aspects 53-57, wherein the CSI-RS burst configuration comprises an aperiodic CSI-RS burst configuration, and wherein the CSI-RS burst configuration indicates at least one burst parameter.

Aspect 59: The method of Aspect 58, wherein the at least one burst parameter comprises a time interval between consecutive CSI-RS occasions of a burst of the at least one burst of CSI-RS occasions.

Aspect 60: The method of Aspect 59, wherein the at least one burst parameter comprises a burst duration, wherein the burst duration comprises a product of time interval and a quantity of time units within a burst of the at least one burst of CSI-RS occasions.

Aspect 61: The method of any of Aspects 53-60, wherein the CSI-RS burst configuration indicates a CSI-RS resource corresponding to a set of CSI-RS occasions in a burst of the at least one burst of CSI-RS occasions.

Aspect 62: The method of any of Aspects 53-61, wherein the CSI-RS burst configuration indicates a plurality of CSI-RS resources, each of the plurality of CSI-RS resources corresponding to a respective CSI-RS occasion of a burst of the at least one burst of CSI-RS occasions.

Aspect 63: The method of Aspect 62, wherein the CSI-RS burst configuration indicates a repetition parameter corresponding to the plurality of CSI-RS resources.

Aspect 64: A method of wireless communication performed by a network node, comprising: Transmitting channel state information (CSI) report configuration information indicative of a CSI-reference signal (CSI-RS) burst configuration corresponding to at least one burst of CSI-RS occasions; and transmitting at least one CSI-RS based on the CSI-RS burst configuration.

Aspect 65: The method of Aspect 64, wherein the CSI-RS burst configuration comprises a periodic CSI-RS burst configuration or a semi-persistent CSI-RS burst configuration, and wherein the CSI-RS burst configuration indicates at least one burst parameter.

Aspect 66: The method of Aspect 65, wherein the at least one burst parameter comprises a burst periodicity, wherein the burst periodicity comprises a product of a CSI-RS periodicity and a quantity of time units within a CSI window.

Aspect 67: The method of either of Aspects 65 or 66, wherein the at least one burst parameter comprises a burst offset, wherein the burst offset is based on a CSI-RS periodicity and an offset associated with a set of time units within a CSI window.

Aspect 68: The method of any of Aspects 65-67, wherein the at least one burst parameter comprises a burst duration, wherein the burst duration comprises a product of a CSI-RS periodicity and a quantity of time units within a burst of the at least one burst of CSI-RS occasions.

Aspect 69: The method of any of Aspects 64-68, wherein the CSI-RS burst configuration comprises an aperiodic CSI-RS burst configuration, and wherein the CSI-RS burst configuration indicates at least one burst parameter.

Aspect 70: The method of Aspect 69, wherein the at least one burst parameter comprises a time interval between consecutive CSI-RS occasions of a burst of the at least one burst of CSI-RS occasions.

Aspect 71: The method of Aspect 70, wherein the at least one burst parameter comprises a burst duration, wherein the burst duration comprises a product of time interval and a quantity of time units within a burst of the at least one burst of CSI-RS occasions.

Aspect 72: The method of any of Aspects 64-71, wherein the CSI-RS burst configuration indicates a CSI-RS resource corresponding to a set of CSI-RS occasions in a burst of the at least one burst of CSI-RS occasions.

Aspect 73: The method of any of Aspects 64-72, wherein the CSI-RS burst configuration indicates a plurality of CSI-RS resources, each of the plurality of CSI-RS resources corresponding to a respective CSI-RS occasion of a burst of the at least one burst of CSI-RS occasions.

Aspect 74: The method of Aspect 73, wherein the CSI-RS burst configuration indicates a repetition parameter corresponding to the plurality of CSI-RS resources.

Aspect 75: An apparatus for wireless communication at a device, comprising a processor; memory coupled with the processor; and instructions stored in the memory and executable by the processor to cause the apparatus to perform the method of one or more of Aspects 1-26.

Aspect 76: A device for wireless communication, comprising a memory and one or more processors coupled to the memory, the one or more processors configured to perform the method of one or more of Aspects 1-26.

Aspect 77: An apparatus for wireless communication, comprising at least one means for performing the method of one or more of Aspects 1-26.

Aspect 78: A non-transitory computer-readable medium storing code for wireless communication, the code comprising instructions executable by a processor to perform the method of one or more of Aspects 1-26.

Aspect 79: A non-transitory computer-readable medium storing a set of instructions for wireless communication, the set of instructions comprising one or more instructions that, when executed by one or more processors of a device, cause the device to perform the method of one or more of Aspects 1-26.

Aspect 80: An apparatus for wireless communication at a device, comprising a processor; memory coupled with the processor; and instructions stored in the memory and executable by the processor to cause the apparatus to perform the method of one or more of Aspects 27-52.

Aspect 81: A device for wireless communication, comprising a memory and one or more processors coupled to the memory, the one or more processors configured to perform the method of one or more of Aspects 27-52.

Aspect 82: An apparatus for wireless communication, comprising at least one means for performing the method of one or more of Aspects 27-52.

Aspect 83: A non-transitory computer-readable medium storing code for wireless communication, the code comprising instructions executable by a processor to perform the method of one or more of Aspects 27-52.

Aspect 84: A non-transitory computer-readable medium storing a set of instructions for wireless communication, the set of instructions comprising one or more instructions that, when executed by one or more processors of a device, cause the device to perform the method of one or more of Aspects 27-52.

Aspect 85: An apparatus for wireless communication at a device, comprising a processor; memory coupled with the processor; and instructions stored in the memory and executable by the processor to cause the apparatus to perform the method of one or more of Aspects 53-63.

Aspect 86: A device for wireless communication, comprising a memory and one or more processors coupled to the memory, the one or more processors configured to perform the method of one or more of Aspects 53-63.

Aspect 87: An apparatus for wireless communication, comprising at least one means for performing the method of one or more of Aspects 53-63.

Aspect 88: A non-transitory computer-readable medium storing code for wireless communication, the code comprising instructions executable by a processor to perform the method of one or more of Aspects 53-63.

Aspect 89: A non-transitory computer-readable medium storing a set of instructions for wireless communication, the set of instructions comprising one or more instructions that, when executed by one or more processors of a device, cause the device to perform the method of one or more of Aspects 53-63.

Aspect 90: An apparatus for wireless communication at a device, comprising a processor; memory coupled with the processor; and instructions stored in the memory and executable by the processor to cause the apparatus to perform the method of one or more of Aspects 64-74.

Aspect 91: A device for wireless communication, comprising a memory and one or more processors coupled to the memory, the one or more processors configured to perform the method of one or more of Aspects 64-74.

Aspect 92: An apparatus for wireless communication, comprising at least one means for performing the method of one or more of Aspects 64-74.

Aspect 93: A non-transitory computer-readable medium storing code for wireless communication, the code comprising instructions executable by a processor to perform the method of one or more of Aspects 64-74.

Aspect 94: A non-transitory computer-readable medium storing a set of instructions for wireless communication, the set of instructions comprising one or more instructions that, when executed by one or more processors of a device, cause the device to perform the method of one or more of Aspects 64-74.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive channel state information (CSI) report configuration information indicative of a computational resource counting configuration associated with processing time domain (TD) CSI associated with a CSI-reference signal (CSI-RS) burst configuration, wherein the CSI-RS burst configuration corresponds to at least one burst of CSI-RS occasions; and
transmit a CSI report based at least in part on the CSI report configuration.

2. The UE of claim 1, wherein the computational resource counting configuration corresponds to a quantity of occupied CSI processing units (CPUs) associated with the CSI report.

3. The UE of claim 2, wherein the quantity of occupied CPUs is based on at least one of a first quantity of time units in a first set of time units, wherein the first set of time units comprises one or more time units within a burst of the at least one burst of CSI-RS occasions.

4. The UE of claim 3, wherein the quantity of occupied CPUs is directly proportional to the at least one of the first quantity of time units or the second quantity of time units.

5. The UE of claim 3, wherein the quantity of occupied CPUs is greater than one based on at least one of the first quantity of time units being greater than one or the second quantity of time units being greater than one.

6-8. (canceled)

9. The UE of claim 2, wherein the occupied CPUs associated with the CSI report correspond to a CPU occupied duration comprising a time period between an occupied duration start time and a time associated with a physical uplink shared channel associated with the CSI report, wherein a burst of the at least one burst of CSI-RS occasions comprises a periodic CSI-RS burst or a semi-persistent CSI-RS burst, wherein the CSI report comprises a periodic CSI report or a semi-persistent CSI report, and wherein the occupied duration start time comprises a latest burst of the at least one burst of CSI-RS occasions that is not later than a CSI reference resource.

10. The UE of claim 2, wherein the occupied CPUs associated with the CSI report correspond to a CPU occupied duration comprising a time period between an occupied duration start time and a time associated with a physical uplink shared channel associated with the CSI report, wherein a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a time associated with a triggering physical downlink control channel occasion.

11. The UE of claim 2, wherein the occupied CPUs associated with the CSI report correspond to a CPU occupied duration comprising a time period between an occupied duration start time and a time associated with a physical uplink shared channel associated with the CSI report, wherein a burst of the at least one burst of CSI-RS occasions comprises a periodic CSI-RS burst or a semi-persistent CSI-RS burst, wherein the CSI report comprises an aperiodic CSI report, and wherein the occupied duration start time comprises a latest burst of the at least one burst of CSI-RS occasions that is not later than a CSI reference resource.

12. The UE of claim 2, wherein the occupied CPUs associated with the CSI report correspond to a CPU occupied duration comprising a time period between an occupied duration start time and a time associated with a physical uplink shared channel associated with the CSI report, wherein a burst of the at least one burst of CSI-RS occasions comprises an aperiodic CSI-RS burst and the CSI report comprises an aperiodic CSI report, and wherein the occupied duration start time comprises a time associated with a triggering physical downlink control channel occasion.

13. The UE of claim 1, wherein the computational resource counting configuration corresponds to a quantity of active CSI-RS resources.

14. The UE of claim 13, wherein the quantity of active CSI-RS resources is based on a first quantity of time units in a first set of time units, wherein the first set of time units comprises one or more time units within a burst of the at least one burst of CSI-RS occasions.

15. The UE of claim 14, wherein the computational resource counting configuration corresponds to a quantity of occupied CSI processing units (CPUs) associated with the CSI report, wherein the quantity comprises a specified fixed value.

16-21. (canceled)

22. A network node for wireless communication, comprising:
a memory; and
one or more processors, coupled to the memory, configured to:
transmit channel state information (CSI) report configuration information indicative of a computational resource counting configuration associated with processing time domain (TD) CSI associated with a CSI-resource signal (CSI-RS) burst configuration, wherein the CSI-RS burst configuration corresponds to at least one burst of CSI-RS occasions; and
receive a CSI report based at least in part on the CSI report configuration.

23. The network node of claim 22, wherein the computational resource counting configuration corresponds to a quantity of occupied CSI processing units (CPUs) associated with the CSI report, wherein the quantity of occupied CPUs is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window.

24. The network node of claim 22, wherein the computational resource counting configuration corresponds to a quantity of active CSI-RS resources, wherein the quantity of active CSI-RS resources is based on at least one of a first quantity of time units in a first set of time units or a second quantity of time units within a second set of time units, wherein the first set of time units comprises one or more time units within a burst of the at least one burst of CSI-RS occasions, and wherein the second set of time units comprises one or more time units within a CSI window.

25. The network node of claim 24, the computational resource counting configuration corresponds to a quantity of ports associated with the quantity of active CSI-RS resources.

26. A UE for wireless communication, comprising:
a memory; and
one or more processors, coupled to the memory, configured to:
receive channel state information (CSI) report configuration information indicative of a CSI-reference signal (CSI-RS) burst configuration corresponding to at least one burst of CSI-RS occasions; and
receive at least one CSI-RS based on the CSI-RS burst configuration.

27. The UE of claim 26, wherein the CSI-RS burst configuration indicates a plurality of CSI-RS resources, each CSI-RS resource of the plurality of CSI-RS resources corresponding to a respective CSI-RS burst of the at least one burst of CSI-RS occasions.

28. The UE of claim 26, wherein the CSI-RS burst configuration comprises an aperiodic CSI-RS burst configuration, and wherein the CSI-RS burst configuration indicates at least one burst parameter, wherein the at least one burst parameter comprises at least one of: a time interval between consecutive CSI-RS occasions of a burst of the at least one burst of CSI-RS occasions, or
a burst duration, wherein the burst duration comprises a product of the time interval and a quantity of time units within a burst of the at least one burst of CSI-RS occasions.

29. A network node for wireless communication, comprising:
a memory; and
one or more processors, coupled to the memory, configured to:
transmit channel state information (CSI) report configuration information indicative of a CSI-reference signal (CSI-RS) burst configuration corresponding to at least one burst of CSI-RS occasions; and
transmit at least one CSI-RS based on the CSI-RS burst configuration.

30. The network node of claim 29, wherein the CSI-RS burst configuration indicates at least one burst parameter comprising at least one of:
a time interval between consecutive CSI-RS occasions of a burst of the at least one burst of CSI-RS occasions, or
a burst duration, wherein the burst duration comprises a product of the time interval and a quantity of time units within a burst of the at least one burst of CSI-RS occasions.

31. The UE of claim 27, wherein the CSI-RS burst configuration indicates a repetition parameter corresponding to the plurality of CSI-RS resources.
